(19) United States
(12) Patent Application Publication
(10) Pub. No.: US 2015/0230512 A1
(43) Pub. Date: Aug. 20, 2015

(54) Food Cleaning Device

(71) Applicant: Ernest Charette, Sarnia (CA)

(72) Inventor: Ernest Charette, Sarnia (CA)

(21) Appl. No.: 14/183,043

(22) Filed: Feb. 18, 2014

(51) Int. Cl. A23N 12/00

(52) U.S. Cl. CPC A23N 12/005

(57) ABSTRACT

A cleaning device with built-in removable brushes/bristles of the present invention composes of a lid and bowl; whereas lid is fitted with the bowl; inside the bowl there is a spinning basket with built-in removable bristles, the crank and knob located on top of lid for spinning action. The crank is attached to the middle section of the brushing basket with an extension part. Spinning action of the brushing basket initiated by rotating the knob. This utility model is a new cleaning device with brush/bristles structure is relatively simple and reliable high strength, beneficial to health, able to clean the surface of fruits or vegetables rapidly.

### APPLICATION

This application claims foreign priority to CN 2013200771414, filed Feb. 19, 2013.

### FIELD OF THE INVENTION

The present invention relates to a food cleaning device, and more particularly, to a cleaning device with built-in removable brushes/bristles.

### DESCRIPTION OF THE PRIOR ART

Fruits and vegetables are part of daily food for any family, but washing them can be a hassle. Moreover, it is not easy to remove outside residue or clean them thoroughly. As a result, this cleaning device concept is created to solve this type of issue. A cleaning device with built-in removable brushes/bristles that allows fruits and vegetables to be cleaned rapidly.

The primary object of the present invention is to provide a cleaning device with built-in removable brushes/bristles, which clean the surface of fruits and vegetables rapidly. The simple and clean structural design make is convenient to use.

A cleaning device with built-in removable brushes/bristles of the present invention is composed of a lid and bowl; where the lid is fitted with the bowl; inside the bowl there is a spinning basket with built-in removable bristles, and the crank and knob located on top of lid is for spinning action. The crank is attached to the middle section of the brushing basket with an extension part. Spinning action of the brushing basket is initiated by rotating the knob.

Preferably, there are brushes/bristles strips insert on the inside of the brushing basket, each brushes/bristles strips has bristles built-in. The brushes/bristles strips are removable and can be changed to a different softness.

Preferably, the brushes/bristles strips insert on the inside of the brushing basket.
Preferably, there are certain numbers of holes on the brushing basket for drainage.
Preferably, there is an anti-slip pad on the bottom of the bowl.
Preferably, there is a handle on the bowl.
Preferably, there are supporting pads on the side of the bowl.
Preferably, the handle and the supporting pads are located at the sides of the bowl.
Preferably, there is a sealing gasket at the edge of the lid.
Preferably, the lid is in transparent circular shape, and fitted with the bowl in same size.

Compared to the prior art, a cleaning device with built-in removable brushes/bristles of the present invention can clean fruits and vegetables rapidly with its simple and clean structural design.

### SUMMARY OF THE INVENTION

This utility model is a new cleaning device with brush/bristles that provides a relatively simple and reliable high strength structure which is beneficial to health, and able to clean the surface of fruits and vegetables rapidly. Compared to the prior art, the present invention has the following advantages.

1. The brushes/bristles provide a deep cleaning of the fruit or vegetables removing outer residue and dirt without damaging even soft or small fruits or vegetables.

2. The design is efficient. The design enables the bowl to quickly clean multiple fruits or vegetables better and faster than hand washing.

3. The capacity of the bowl is efficiently employed to accommodate more fruits and vegetables in a confined space.

4. The bowl may be, in one embodiment, provided with an anti-slip pad at the bottom to keep the device stable while in operation.

5. The material and removable bristles, permits the bowl to be easily cleaned and stored for re-use.

### BRIEF DESCRIPTION OF THE DRAWINGS

FIG. 1 is an appearance view according to a preferred embodiment of the present invention;

FIG. 2 is a schematic view showing the brushing basket according to the preferred embodiment of the present invention;

FIG. 3 is a side view showing the brushing basket according to the preferred embodiment of the present invention;

FIG. 4 is a perspective view showing the cleaning device with built-in removable brushes/bristles during application according to the preferred embodiment of the present invention;

FIG. 5 is a perspective view showing the cleaning device with built-in removable brushes/bristles.

FIG. 6 is a three dimensional view of all the parts and embodiments.

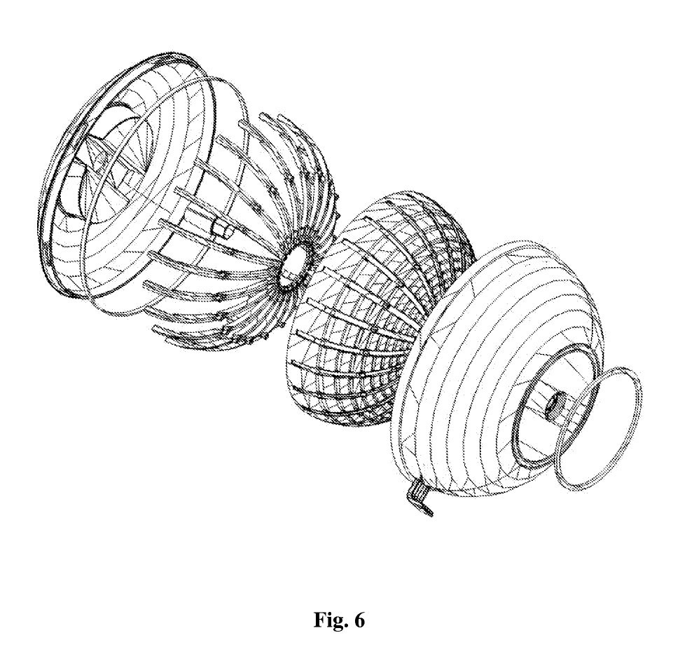

### FIGURES INDICATOR

1 Lid;

2 crank;

3 Knob;

4 Bowl;

5 Handle;

6 Brushing Basket;

7 Brushes/Bristles Strips

8 Brushes/Bristles

9 Anti-Slip Pad

10 Extension Part

11 Supporting Pads

### DETAILED DESCRIPTION OF THE PREFERRED EMBODIMENTS

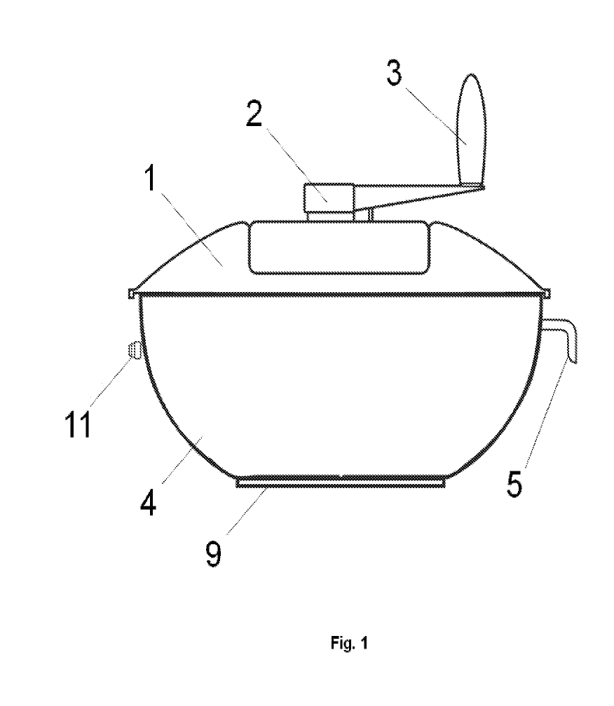

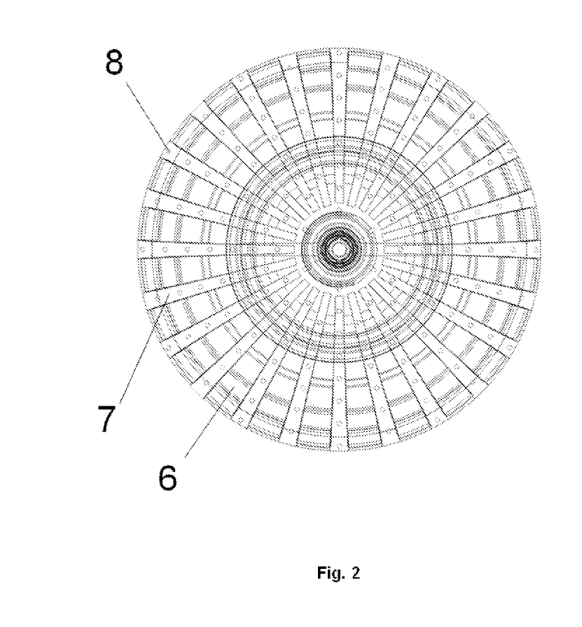

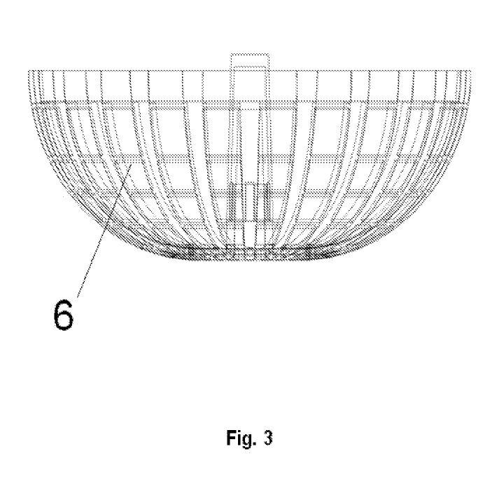

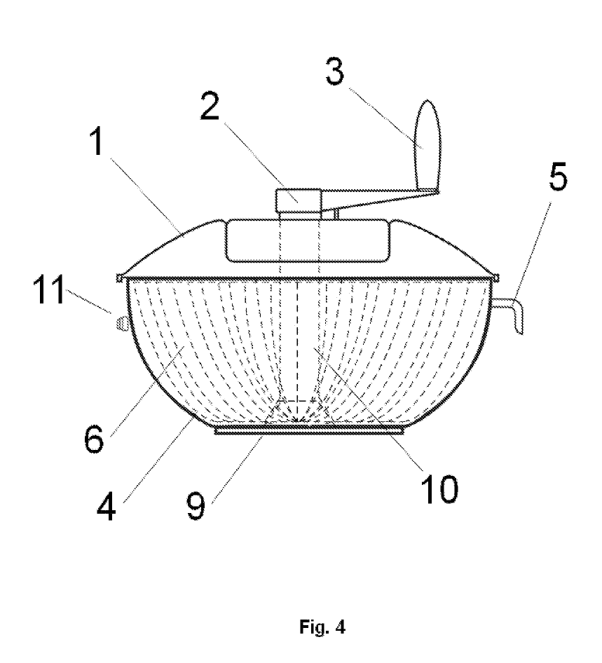

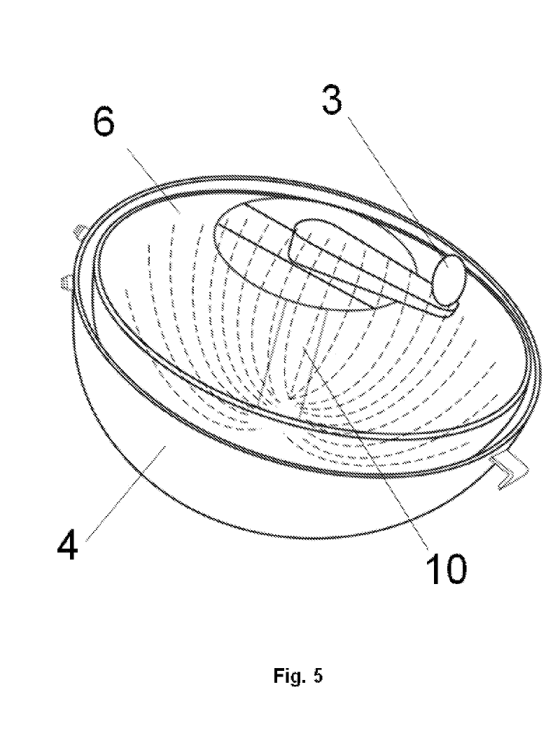

Embodiments of the present invention will now be described, by way of example only, with reference to the accompanying drawings (FIG. 1 to FIG. 5).

As demonstrated from FIG. 1 to FIG. 5, A cleaning device with built-in removable brushes/bristles of the present invention composes with a lid (1) and bowl (4); lid (1) fitted with the bowl (4); inside the bowl (4) there is a spinning brushing basket with built-in removable bristles (6), the crank (2) and knob (3) located on top of lid for spinning action. The crank (2) is attached to the middle section of the brushing basket (6) with an extension part (10). Spinning action of the brushing basket (6) initiated by rotating the knob (3). Inside the brushing basket (6) it has the removable brushes/bristles strips (7), each brushes/bristles strips (7) has individual set of brushes/bristles (8). Each brushes/bristles strips (7) are removable and the bristles can be changed to different type of softness.

There are certain numbers of holes on the brushing basket (6) for drainage.

There is an anti-slip pad (9) on the bottom of the bowl (4) to prevent spinning action to damage the surface while using the device.

There is a handle (5) on the bowl (4) to leverage while using the device. Supporting pads (11) located on the side of the bowl (4), it used to increase stability by supporting the tilted body of bowl (4) while using. Both handle (5) and supporting pads (11) are located at the sides of the bowl (4).

A sealing gasket located at the edge of the lid (1), it creates sealing function to prevent leaking when using the device. The lid is in transparent circular shape, and fitted with the bowl in same size.

The use process of the present invention, place fruits or vegetables into the brushing basket (6), close the lid (1), turns the knob (3). Turning the knob (3) creates momentum to the extension part (10) then it generates spinning action to the brushing basket (6). Bristles on the brushing basket (6) clean the surface of fruits and vegetables rapidly from its spinning action. It can remove dirt or soil from the surface of fruits and vegetables effectively and clean them thoroughly.

Accordingly, the cleaning device with built-in removable bristles of the present invention can clean surface of fruits and vegetables rapidly and thoroughly very easy with its simple and strong structural design.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A cleaning device, comprising:
A bowl shaped main body comprising of a lid (1) a bowl (4) ; where the lid (1) snaps onto the top of the bowl (4) , and inside the bowl (4) a brushing basket (6) , and on top of the lid (1) has a rotating section with the crank (2) and a knob (3) ; whereas the crank (2) attaches to the center of the brushing basket (6) by connecting with the extension part (10), where rotation from the crank (3) creates spinning action to the brushing basket (6).

2. The cleaning device as claimed in claim 1, wherein cleaning device with brushes/bristles , specified: Inside the brushing basket (6) has the removable brushes/bristles strips (7), each brushes/bristles strips (7) has individual set of brushes/bristles (8)

3. As stated in claim 2, a cleaning device with brushes/bristles , specified : the removable brushes/bristles strips (7) install/insert on the inside of the brushing basket (6)

4. As stated in claim 3, a cleaning device with brushes/bristles, specified: there are a certain number of holes on the brushing basket (6) for drainage.

5. As stated in claim 4, a cleaning device with brushes/bristles, specified: it has the anti-slip pad (9) on the bottom of the bowl(4)

6. As stated in claim 5, a cleaning device with brushes/bristles, specified: there is the handle (5) on the bowl (4).

7. As stated in claim 6, a cleaning device with brushes/bristles, specified: there are supporting pads (11) at the side of the bowl (4).

8. As stated in claim 7, a cleaning device with brushes/bristles, specified: the handle (5) and the supporting pads (11) are located at the side of the bowl (4).

9. As stated in claim 8, a cleaning device with brushes/bristles, specified: A sealing gasket is included at the edge of the lid (1).

10. As stated in claim 9, a cleaning device with brushes/bristles, specified: The Lid (1) is in transparent circular shape and the bowl (4) is fitted same size with the lid (1)
